(19) United States
(12) Patent Application Publication
(10) Pub. No.: US 2024/0096214 A1
(43) Pub. Date: Mar. 21, 2024

(54) METHOD AND SYSTEM FOR CLASSIFYING VEHICLES BY MEANS OF A DATA PROCESSING SYSTEM

(71) Applicant: NEC Laboratories Europe GmbH, Heidelberg (DE)

(72) Inventors: Antonio ALBANESE, Heidelberg (DE); Vincenzo SCIANCALEPORE, Heidelberg (DE); Xavier COSTA-PEREZ, Heidelberg (DE)

(21) Appl. No.: 18/275,623

(22) PCT Filed: Apr. 30, 2021
(86) PCT No.: PCT/EP2021/061378

§ 371 Date: Aug. 3, 2023

(30) Foreign Application Priority Data
Mar. 10, 2021 (EP) 21161805.3

(51) Int. Cl. G08G 1/017; G06N 3/08

(52) U.S. Cl. CPC G08G 1/017; G06N 3/08

(57) ABSTRACT

A method for classifying vehicles by means of a data processing system according to the nature of their vehicle drivers includes collecting driving data regarding vehicles driving in a predefined local area within a predefined time window, learning a driving policy of one or more vehicles in the local area from the driving data, generating or using a local predictor indicating a prediction of a definable driver behavior over a definable time horizon. The method further shares the local predictor with other vehicles in the local area to provide at least one combined predictor, redistributes the at least one combined predictor to vehicles in the local area, and locally classifies at least one of the vehicles based on the at least one combined predictor and/or the local predictor into a definable vehicle class for providing at least one local classification.

### CROSS REFERENCE TO RELATED APPLICATIONS

This application is a U.S. National Phase application under 35 U.S.C. § 371 of International Application No. PCT/EP2021/061378, filed on Apr. 30, 2021, and claims benefit to European Patent Application No. EP 21161805.3, filed on Mar. 10, 2021. The International Application was published in English on Sep. 15, 2022 as WO 2022/189004 A1 under PCT Article 21(2).

### FIELD

The present invention relates to a method and system for classifying vehicles by means of a data processing system.

### BACKGROUND

Such methods and systems are known from prior art, wherein corresponding prior art documents are listed as follows:
[1] D. Petrović, R. Mijailović, D. Pešić, “Traffic Accidents with Autonomous Vehicles: Type of Collisions, Manoeuvres and Errors of Conventional Vehicles' Drivers”, Elsevier Transportation Research Procedia, vol. 45, pp. 161-168, 2020
[2] Katherine Shaver, “Why your favorite bench might be there to thwart a terrorist attack”, The Washington Post, August 2018, [Online], Available at https://www.washingtonpost.com/local/trafficandcommuting/why-your-favorite-bench-might-be-there-to-thwart-a-terrorist-attack/2018/08/27/28a863fc-9b49-11e8-b60b-1c897f17e185 story.html, Accessed 22 Feb. 2021
[3] L. Zanzi, A. Albanese, V. Sciancalepore and X. Costa-Perez, “NSBchain: A Secure Blockchain Framework for Network Slicing Brokerage,” ICC 2020-2020 IEEE International Conference on Communications, ICC, Dublin, Ireland, 2020, pp. 1-7, doi: 10.1109/ICC40277.2020.9149414.
[4] G. De Angelis, A. De Angelis, V. Pasku, A. Moschitta and P. Carbone, “A simple magnetic signature vehicles detection and classification system for Smart Cities,” 2016 IEEE International Symposium on Systems Engineering, ISSE, Edinburgh, 2016, pp. 1-6, doi: 10.1109/SysEng.2016.7753170.
[5] T. Moranduzzo and F. Melgani, “Automatic Car Counting Method for Unmanned Aerial Vehicle Images,” in IEEE Transactions on Geoscience and Remote Sensing, vol. 52, no. 3, pp. 1635-1647, March 2014, doi: 10.1109/TGRS.2013.2253108.
[6] Jiajun Zhu, David I. Ferguson, and Dmitri A. Dolgov. “System and method for predicting behaviors of detected objects through environment representation”, U.S. Pat. No. 10,564,639 B1, granted February 2014.
[7] Dougherty, John Anthony, Jordan Scott Burklund, Kristen Wagner Cerase, Stephen Marc Chaves, Ross Eric Kessler, Paul Daniel Martin, Daniel Warren Mellinger III, and Michael Joshua Shomin. “Methods And Systems For Managing Interactions Between Vehicles With Varying Levels Of Autonomy.” U.S. patent application U.S. Ser. No. 16/727,179 A, filed Jul. 2, 2020.

The past few years have seen a tremendous hype around the autonomous driving trend. As car manufacturers are developing Self-driving—SAE level3+—systems to improve the safety and comfort of passengers, public or non-public traffic regulators, TRs, need to establish new procedures to make smooth the coexistence between autonomous and human-driven vehicles. For instance, the higher caution of autonomous vehicles, AVs, near pedestrians represents the major cause of accidents with AVs being hit from behind after stopping to give the right-of-way to pedestrians, see [1].

Modern city architecture is evolving to counter the threat of terrorism. Instead of deploying bollards or concrete barriers, sidewalks and squares are going through a vast redesign process to keep their pleasantness while being able to thwart a terrorist vehicle-ramming attack, see [2]. Besides, high-risk city areas, e.g., central areas of particular tourism interest, may be restricted to AVs only, thus calling for reliable systems to identify and classify vehicles as granting access to wrong vehicles would defeat the purpose of such protective solutions.

### RELATED WORK

From the road-system viewpoint, we are witnessing the emergence of a novel security issue, i.e., the occurrence of malfunctions in AVs due to chance or malicious tampering of their control units. Such malfunctions may result in a discrepancy between the driver nature announced by a vehicle and the actual one. Currently, a few technical solutions to improve the reliability of identity management, e.g., blockchains involving all the above-mentioned parties or the usage of Trusted Execution Environments, TEEs, at the vehicle side, are available, see [3]. However, the scenario is so critical that traffic regulators, TRs, need a backup solution to probe the nature of vehicles in circulation on the road, despite their announcements to the road management entity, which can be either validated or disproved.

Automatic traffic monitoring including vehicle detection and tracking has been widely investigated in the past decades. Some literature makes use of sensors built in the road infrastructure, e.g., buried induction loops, to design a passive system to evaluate the flow of cars traversing specific areas and determine the vehicle model by comparing its electromagnetic fingerprint signature against a previously recorded reference, see [4]. Another common approach is to use computer vision algorithms on the footage generated by fixed cameras pointed at the road infrastructure, Unmanned Aerial Vehicles, UAVs, hovering on the area or even images coming from geostationary satellites, see [5].

However, none of these methods can be applied to discern between AVs or human-driven cars, which constitutes the open problem addressed by our invention. The reason is based on the fact that the two classes show significant differences only within isolated and sporadic traffic events while being very similar in their conventional—for example macro—mobility patterns, e.g., following the straight middle line on a two-lane road. Therefore, a classifier would need to observe the target vehicles over a big enough time window in order to catch this kind of events. In particular, state-of-the-art solutions are based on images that are either fixed in case of roadside cameras or satellites, which are also too distant to capture such movements, or produced by battery-operated UAVs, which are impractical and raise a number of efficiency concerns. Furthermore, although merging the data generated by fixed road sensors such as induction loops or cameras is a viable option to keep track of a target vehicle along its motion trajectory, it may require high-density sensor deployments, which are not economical in less heavily trafficked areas, e.g., rural.

The authors of [6] make a step in this direction by envisioning a method to forecast objects trajectories in the environment. The AV determines the object classification and state information, i.e. location, traffic lane in which the detected object is traveling, speed, acceleration, entry onto a road, exit off of a road, activation of headlights, activation of taillights, or activation of blinkers. However, they do not take into account the relationships between the object and the environment, as no external environmental features are part of the object state.

Moreover, [6] envisions a method of controlling an autonomous vehicle, namely adjusting a driving parameter of the autonomous vehicle based on the determined autonomous capability metric of each of the identified vehicles. To this aim, AVs can form a cluster with one or more cars and share various information, e.g., the level of autonomy or speed, via Vehicle-to-Vehicle, V2V, communications. The system predicts the autonomous driving capabilities of a target through the observation of its external or non-external hardware equipment or its driving behavior. This is performed by checking a set of features, such as the regularity of vehicle operations, the degree to which the nearby vehicle tracks a center of a driving lane number of driving errors per unit time, the compliance with local road and safety rules, the reaction time of the autonomous vehicle or its responsiveness. However, the proposed system includes a fixed number of test features, which do not necessarily capture the complexity of the driving behavior of the target.

Further prior art reference US 2020/0207360 A1 discloses a method of determining the autonomous capability metric, ACM, of a target vehicle this includes the determining a level of autonomy of the target vehicle such as whether the vehicle is in full autonomous mode, in semi-autonomous mode or in manual mode with the help of vehicle autonomous driving system, VADS, component that collects data from various sensors present in the vehicle, e.g. camera, radar, LIDAR etc. The autonomous vehicle forms a cluster or caravan with one or more cars and share various information with other cars in caravan like level of autonomy, speed, velocity etc. The VADS component may be configured to detect the level of autonomy of target vehicles with the help of various machine learning techniques or some prediction methods. The VADS component may adjust or modify the behaviour model of the other vehicle to more accurately reflect the determined level of autonomy of the target vehicle.

Further prior art reference U.S. Pat. No. 8,660,734 B2 discloses a method to detect the external objects with the help various type of sensors. The processor then analyse the data and determine the classification and state of the target vehicle. The state of target object can be determined with the help of location, traffic lane in which the object is traveling, speed, acceleration, entry onto a road, exit off of a road, and activation of headlights, activation of taillights, or activation of blinkers this information can also be used for classification of the target object. These observation and classification can be achieved with the help of various types of machine learning techniques. The classification and state of the target vehicle can be shared to other neighbouring vehicle through a server which can be seen as a central server with which a group of cars are connected.

The traffic monitoring solutions developed and deployed for decades are not suitable for the incoming AVs traffic. Although there are no clear policies to regulate the interaction between human-driven and autonomous vehicles yet, it is mandatory for traffic regulators to determine the nature of vehicle drivers with high confidence and in an independent manner.

### SUMMARY

In an embodiment, the present disclosure provides a method for classifying vehicles by a data processing system according to the nature of their vehicle drivers. The method includes collecting driving data regarding vehicles driving in a predefined local area within a predefined time window, learning a driving policy of one or more vehicles in the local area from the driving data, generating or using a local predictor indicating a prediction of a definable driver behavior over a definable time horizon. The method further shares the local predictor with other vehicles in the local area to provide at least one combined predictor, redistributes the at least one combined predictor to vehicles in the local area, and locally classifies at least one of the vehicles based on the at least one combined predictor and/or the local predictor into a definable vehicle class for providing at least one local classification.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows building blocks of an embodiment of the invention and respective executing entities; and

FIG. 2 shows an edge computing scenario according to an embodiment of the invention.

### DETAILED DESCRIPTION

In an accordance with an embodiment, the present invention improves and further develops a method and system for classifying vehicles by means of data processing system for providing an efficient and reliable classification of vehicles by simple means.

In accordance with another embodiment, the present invention provides a method for classifying vehicles by means of a data processing system, particularly for classifying vehicles according to the nature of their vehicle drivers, comprising the following steps:
collecting driving data regarding vehicles driving in a predefined local area within a predefined time window;
learning a driving policy of one or more vehicles in said local area from said driving data;
generating or using a local predictor indicating a prediction of a definable driver behavior over a definable time horizon;
sharing the local predictor with other vehicles in said local area to provide at least one combined predictor;
redistributing the at least one combined predictor back to vehicles in said local area; and
locally classifying at least one of said vehicles based on the at least one combined predictor and/or the local predictor into a definable vehicle class for providing at least one local classification.

In accordance with another embodiment, the present invention provides a system for classifying vehicles by means of a data processing system, particularly for classifying vehicles according to the nature of their vehicle drivers, comprising:
collecting means for collecting driving data regarding vehicles driving in a predefined local area within a predefined time window;
learning means for learning a driving policy of one or more vehicles in said local area from said driving data;
generating or using means for generating or using a local predictor indicating a prediction of a definable driver behavior over a definable time horizon;
sharing means for sharing the local predictor with other vehicles in said local area to provide at least one combined predictor;
redistributing means for redistributing the at least one combined predictor back to vehicles in said local area; and
classifying means for locally classifying at least one of said vehicles based on the at least one combined predictor and/or the local predictor into a definable vehicle class for providing at least one local classification.

According to the invention it has been recognized that it is possible to provide a very efficient and reliable method by a local approach exploiting driving data regarding vehicles driving in a predefined local area within a predefined time window. Further, a driving policy of one or more vehicles in said local area is learnt from said driving data. Additionally, a local predictor indicating a prediction of a definable driver behavior over a definable time horizontal is generated or used in this method. Then, the local predictor is shared with other vehicles in said local area to provide at least one combined predictor for better accuracy. After a redistribution of the at least one combined predictor back to vehicles in said local area at least one of said vehicles is locally classified based on the at least one combined predictor and/or the local predictor into a definable vehicle class for providing at least one local classification. The use of the at least one combined predictor and/or the local predictor provides a high accuracy in classification of the at least one of said vehicles. The proposed method and system provide high accuracy in the detection and classification process and low complexity.

Thus, on the basis of the invention an efficient and reliable classification of vehicles by simple means is provided.

According to an embodiment of the invention the vehicle class can provide information whether a vehicle is autonomously or human-driven. This information about the nature of vehicle drivers is very important for a lot of security questions and protective solutions in traffic regulation.

Within a further embodiment the driving data can be collected from at least one sensor or onboard sensor of one or more vehicles, preferably of one or more vehicles within the predefined local area, and/or from at least one road or environment infrastructure sensor. This will emphasize that one or more suitable sensors can be provided onboard, within a vehicle other than a target vehicle and/or externally out of vehicles. Alternatively or additionally road or environment infrastructure sensors can be used for providing the driving data.

In a further embodiment the driving data can comprise abstract data features and/or synthetized data features. All kinds of suitable data can be used within embodiments of the present invention depending from individual application situations.

According to a further embodiment, during the learning step a proprietary implementation of a vehicle or autonomous vehicle can be preserved. There is no amendment or change in a proprietary implementation.

In a further embodiment the local predictor can be provided as a locally fitted predictor, which is adapted to the individual application situation of the method. The generation or use of more than one local predictor is possible. Generally, one or more predictors can be tailored onto two classification classes or vehicle classes.

According to a further embodiment the classifying step can be based on the predictor delivering the higher or highest accuracy score. This will provide a very exact classification.

Within a further embodiment and for providing a further enhanced accuracy of the classification local classifications can be shared with other vehicles, preferably for combining them. This will also provide higher accuracy of the method.

In a further embodiment confidence estimates associated with local classifications can be shared with other vehicles, preferably for combining them. This will also provide higher accuracy of the method.

According to a further embodiment one or more of said vehicles—one or more target vehicles—can be globally classified by combining outputs of preferably all local classifications and/or their associated confidence estimates. This feature provides a very accurate and reliable classification of vehicles.

Within a further embodiment at least one classification output can be sent to traffic authorities systems. This will provide a very reliable enforcement of for example appropriate automatic control policies based on the types of vehicles.

In a further embodiment the method can be performed on one or more vehicles and/or at one or more external or edge data processing systems. The method can be performed on autonomous and/or on human-driven vehicles. Also the corresponding system can be provided on autonomous and/or on human-driven vehicles. Alternatively or additionally sections of the method and/or components of the system and/or data processing system can run at a network edge and can be fed with driving data.

According to a further embodiment the method can be performed as a machine learning approach, preferably in an edge computing, EC, network with edge computing servers. Such a realization of the method and system can depend on the individual application situation. A machine learning approach provides a very efficient and reliable classification of vehicles, wherein permanent and continuous updating of the method due to changing traffic situation is possible.

In a further embodiment the method can be performed with computing servers, preferably edge computing servers, communicating via direct links, through a cloud backend and/or through a connected, cooperative automated mobility platform, CCAM. The type of communication can be selected for optimizing accuracy in the classification of vehicles.

According to a further embodiment, in the method the vehicles can train a neural network and update weights on assigned servers or edge computing servers. Distributed learning mechanisms among a network provided by the servers can be put in place to update a global model within the network.

Advantages and aspects of embodiments of the present invention are listed as follows:

According to embodiments of the invention autonomous vehicles can be detected by predicting driving features and classifying them based on the respective predictors scores.

In further embodiments the classification output can be sent to traffic authorities systems to enforce appropriate automatic control policies based on the type of vehicles.

Within the scope of the invention there can be provided a method for automatically detecting whether a vehicle is autonomously or human-driven. Such a method can comprise one or more of the following steps:
1) Learning the driving policy of an autonomous vehicle according to abstract data features and/or driving data collected in some time window thereby preserving the proprietary implementation of the autonomous vehicle or driving unit.
2) Sharing at least one or more local predictors within the vehicle pool—provided by the vehicles—to combine them for better accuracy.
3) Redistributing the combined—possibly better—predictor back to the vehicles in the vehicle pool.
4) Locally classifying target vehicles based on the predictor delivering the higher accuracy score.
5) Sharing the local classifications and/or associated confidence estimates within the vehicle pool to combine them for better accuracy.
6) Globally classifying target vehicles by combining all local classification outputs and/or their confidence estimates within the vehicle pool.

On the contrary to the system of [6], for example, embodiments of our solution do not rely on explicit assessments of Key Performance Indicators, KPIs, of target vehicles but rather can infer the driving behavior as is by means of an ad-hoc predictor, as discussed later in this document. Moreover, embodiments of our solution can enable a distributed learning approach in which all AVs in the area managed by the same TR can participate to the training of the global models—predictor and classifier.

According to a further embodiment of the invention there can be provided a system to automatically determine if a vehicle on the road is an autonomous or human-driven entity by exploiting other vehicles' onboard sensors driving within the same area and/or road infrastructure sensors thereby building a classifier based on locally fitted predictors.

An embodiment of the present invention provides an independent backup system capable of i) validating the AV/human-driver announcement of the vehicles and minimizing the data scarcity problem of state-of-the-art solutions in less populated areas.

There are several ways how to design and further develop the teaching of the present invention in an advantageous way. To this end it is to be referred to the following explanation of examples of embodiments of the invention, illustrated by the drawing.

Embodiments of the present invention overcome the above-mentioned prior art limitations by turning the increasingly higher spread of connected vehicles with sensors on the road and in the infrastructure into an advantage by exploiting the large amount of data they acquire locally.

An embodiment of the invention involves a service running on vehicles of both classes—not limited to, e.g., also running at the network edge and fed with car sensor data—that performs two main tasks, described in the following. Moreover, it brings in a novel approach to classification, based on the performances of predictors tailored onto two classification classes, for example autonomous or human-driven vehicles.

The training of a local model constitutes the first task. Such model aims at learning the driving policy of the vehicle driver, i.e., predicting the driver behavior in terms of steering wheel angle, throttling and/or breaking and/or driving precision, based on a given window of collected sensor data. Sensor data include a rich set of features such as the current velocity and acceleration vectors of the vehicle, its past trajectory obtained by means of e.g. Global Satellite Navigation Systems, GNSSs, camera or radar/LiDAR images of the surroundings. It is worth pointing out that the list of features can be straightforwardly adapted based on the pool of available onboard and infrastructure sensors.

Hence, the local predictor indicates or outputs a prediction of the driver behavior over a specific time horizon. The past time window and the future horizon are tuned to minimize the prediction error, as per the literature related to the particular implementation of the predictor.

Learning the driving policy of an AV by looking at the driving behavior based on synthetized data features is beneficial as i) it—likely—spares the complexity of the autonomous driving model ii) preserves the proprietary implementation of the autonomous driving unit, which does not need to be disclosed, thus encouraging vehicle manufacturers to implement the system. Nonetheless, even though it cannot achieve the accuracy needed to perform an autonomous driving task, the predictor is still capable of delivering good enough performances for the final classification purpose.

Upon completion of the training phase, tailored predictors are shared with traffic regulators, TRs, which collect predictors tailored on both classes. Next, TRs combine the retrieved predictors to build a couple of finer predictors by combining the ones they have at disposal. Note that after the first training phase, vehicles keep training their predictors in an online fashion.

Along the lines of a federated-like scheme, the final predictors are then shared with the vehicles. Each vehicle can now execute the second task, i.e., applying both predictors to any of the vehicles in its surroundings as most of the input feature set can be derived by their macroscopic behavior. Unobtainable features, e.g., target vehicle camera images, can be dealt with by means of encoding techniques or generative methods, which come together in an adaptation layer for the model, e.g., pre-trained Generative Adversarial Networks models to generate the missing images from the target vehicle point of view.

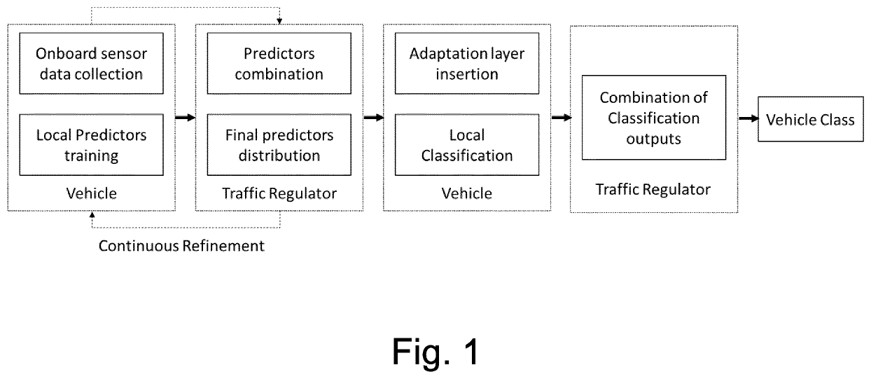

By looking at the prediction performances of both predictors and being aware about which kind of vehicles have been trained—either AV or human-driven—, our invention classifies the target vehicle according to the predictor class providing the best score. The high-level building blocks of our invention are depicted in FIG. 1 along with the entity performing each function, namely a vehicle or the TR. After collecting onboard and infrastructure sensor data, each vehicle trains a local predictor, which is then shared with the TR in charge of combining all received predictors and distributing the final predictors back to the vehicles. This process keeps going in a closed-loop thereby improving the accuracy of predictors by increasing the number of observed samples and involved vehicles over time. Upon reception of the refined predictors, the vehicle performs target classification and returns its classification output enriched with a measure of confidence to the TR, which is finally able to combine all classification outputs and derive the vehicle class and the overall confidence.

In the following are shown some embodiments of the invention obtained via a machine learning approach in an Edge Computing, EC, network scenario:

### Embodiment 1

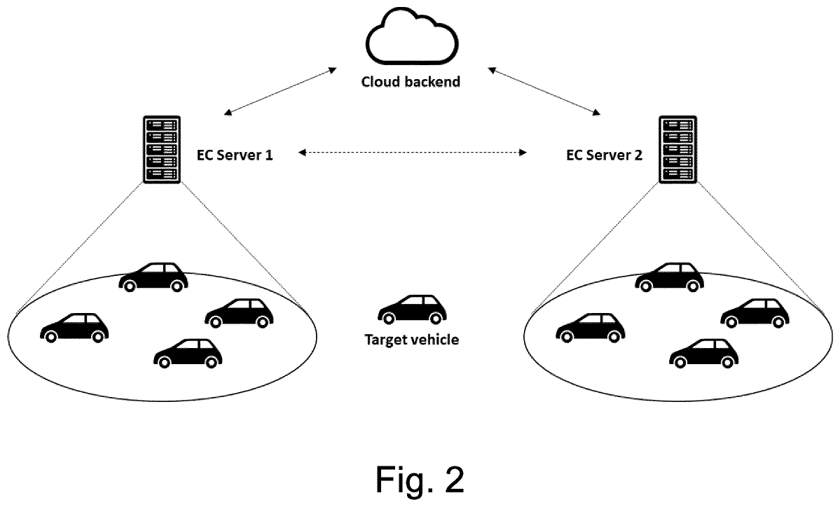

In this embodiment, we present a possible implementation of our invention in a scenario with Edge Computing, EC, servers, as shown in FIG. 2. In particular, we assume a multi-server architecture, in which EC servers can communicate via direct links or through the cloud backend and/or a connected, cooperative automated mobility platform, CCAM.

As neural-network models are easy to distribute by sharing the weights of the links among neurons with all federated parties, all vehicles train the same neural network model and update the weights on their assigned EC server. Note that distributed learning mechanisms among EC servers can be put in place to update a global model within the network.

After the training phase, the final predictors are returned to the vehicles. The latter applies the predictors to their target vehicles by retrieving the required target feature set through generative models, e.g., Generative Adversarial Networks models.

By selecting the predictor delivering the highest accuracy, each vehicle gets a classification of target vehicles. Whenever a vehicle has got a classification output for any target vehicle, it sends it to its EC server, which collects all classifications and assesses their confidence based on the number of vehicles which have provided a classification output for the same target or how much time has the target been in visibility of how many vehicles. Finally, the EC server or servers outputs labels and respective confidence levels for TRs to check on the legitimateness of all vehicles on the road.

Note that embodiments of this system are not necessarily offline, as continuous refinement to predictors and classifiers can be brought by continuous learning techniques applied to both vehicles and EC servers.

The owners of the CCAM platforms—traffic regulator entities, car manufacturers and/or mobile operators—might build on the AV classifications to enhance road safety by instructing traffic authorities to prevent accidents as well as drivers subscribed to their services.

### Embodiment 2

In this embodiment, we take advantage of the upcoming network-slicing paradigm and assume that a car manufacture holds a network slice within some service operator network connecting all their vehicles. As car manufactures are most concerned with the safety of their customers, they can implement our invention to classify vehicles from other vendors and tune the onboard advanced driver-assistance systems, ADASs, based on their nature.

Specifically, in these operational conditions, vehicles from one manufacture can share their predictive models in order to build a couple of accurate predictors that, in turn, can be distributed back to the vehicles. Again, such predictors can be employed for vehicle classification.

Note that the accuracy of this approach grows with the quantity of available data for the predictors training as well as with the number of vehicles providing classification outputs for a specific target.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method for classifying vehicles by a data processing system according to a nature of their vehicle drivers, the method comprising:
collecting driving data regarding vehicles driving in a predefined local area within a predefined time window;
learning a driving policy of one or more vehicles in the local area from the driving data;
generating or using a local predictor indicating a prediction of a definable driver behavior over a definable time horizon;
sharing the local predictor with other vehicles in the local area to provide at least one combined predictor;
redistributing the at least one combined predictor to vehicles in the local area; and
locally classifying at least one of the vehicles based on the at least one combined predictor and/or the local predictor into a definable vehicle class for providing at least one local classification.

2: The method according to claim 1, wherein the vehicle class provides information on whether a vehicle is autonomously or human-driven.

3: The method according to claim 1, wherein the driving data is collected from at least one sensor or onboard sensor of one or more vehicles within the predefined local area and/or from at least one road or environment infrastructure sensor.

4: The method according to claim 1, wherein the driving data comprises abstract data features and/or synthetized data features.

5: The method according to claim 1, wherein during the learning step a proprietary implementation of a vehicle or autonomous vehicle is preserved.

6: The method according to claim 1, wherein the classifying step is based on the predictor delivering the higher or highest accuracy score.

7: The method according to claim 1, wherein local classifications are shared with other vehicles.

8: The method according to claim 1, wherein confidence estimates associated with local classifications are shared with other vehicles.

9: The method according to claim 1, wherein one or more of the vehicles are globally classified by combining outputs of all local classifications and/or their associated confidence estimates.

10: The method according to claim 1, wherein at least one classification output is sent to traffic authorities systems.

11: The method according to claim 1, wherein the method is performed on one or more vehicles and/or at one or more external or edge data processing systems.

12: The method according to claim 1, wherein the method is performed as a machine learning approach.

13: The method according to claim 1, wherein the method is performed with computing servers communicating via direct links, through a cloud backend and/or through a connected, cooperative automated mobility platform (CCAM).

14: The method according to claim 1, wherein in the method the vehicles train a neural network and update weights on assigned servers or edge computing servers.

15: A system for classifying vehicles by a data processing system according to a nature of their vehicle drivers, the system comprising:
collecting means for collecting driving data regarding vehicles driving in a predefined local area within a predefined time window;
learning means for learning a driving policy of one or more vehicles in the local area from the driving data;
generating or using means for generating or using a local predictor indicating a prediction of a definable driver behavior over a definable time horizon;
sharing means for sharing the local predictor with other vehicles in the local area to provide at least one combined predictor;
redistributing means for redistributing the at least one combined predictor to vehicles in the local area; and
classifying means for locally classifying at least one of the vehicles based on the at least one combined predictor and/or the local predictor into a definable vehicle class for providing at least one local classification.

16: The method according to claim 7, wherein the local classifications are shared with other vehicles for combining the local classifications.

17: The method according to claim 8, wherein confidence estimates associated with local classifications are shared with other vehicles for combining the confidence estimates.

18: The method according to claim 9, wherein the one or more of the vehicles are one or more target vehicles.

19: The method according to claim 12, wherein the machine learning approach is performed in an edge computing network with edge computing servers.

20: The method according to claim 13, wherein the computing servers comprise edge computing servers.
